(19) United States
(12) Patent Application Publication
(10) Pub. No.: US 2025/0198712 A1
(43) Pub. Date: Jun. 19, 2025

(54) METHOD FOR PRODUCING A MAGNETOCALORIC HEAT EXCHANGER ELEMENT

(71) Applicant: MAGNOTHERM SOLUTIONS GMBH, Darmstadt (DE)

(72) Inventors: Falk MÜNCH, Darmstadt (DE); Maximilian FRIES, Aschaffenburg (DE); Ulysse ROCABERT, Darmstadt (DE)

(73) Assignee: MAGNOTHERM SOLUTIONS GMBH, Darmstadt (DE)

(21) Appl. No.: 18/845,836

(22) PCT Filed: Mar. 9, 2023
(86) PCT No.: PCT/EP2023/056065

§ 371 Date: Sep. 10, 2024

(30) Foreign Application Priority Data
Mar. 10, 2022 (EP) 22161486.0

(51) Int. Cl. F28F 21/08; C23C 2/02; C23C 2/04; F25B 21/00; H01F 41/02

(52) U.S. Cl. CPC F28F 21/081; C23C 2/024; C23C 2/04; F25B 21/00; H01F 41/02; F25B 2321/002

(57) ABSTRACT

A low-cost, resource-saving, easy-to-perform, preferably harmless and fault-tolerant process is disclosed with which a durable, robust, chemically and mechanically stable heat exchanger element with advantageous thermohydraulic and magnetic properties can be produced. The method comprises:
providing a magnetocaloric substrate with a plurality of channels or pores which preferably form continuous channels,
immersion of the substrate in a tempered aqueous reaction solution, which leads to an autocatalytic-chemical deposition of a metal coating on the surface of the substrate.

### CROSS-REFERENCE TO RELATED APPLICATION

This application is a national phase of International Application No. PCT/EP2023/056065, filed Mar. 9, 2023, which is hereby incorporated by reference in its entirety.

### FIELD

This disclosure relates to a method of manufacturing a magnetocaloric heat exchanger element. It also relates to a heat exchanger element produced by such a method and to a heat pump or cooling or heating device comprising such a heat exchanger element. This disclosure also relates to a nickel-based deposition solution and a copper-based deposition solution, in particular for use in said process.

### BACKGROUND

In addition to selecting a high-performance functional material that is tailored to the desired temperature range and appropriately cost-effective, a suitable design of the magnetocaloric heat exchanger is a prerequisite for economically exploiting the theoretically expected energy efficiency gains when using magnetocaloric materials in heat pumps and cooling devices. This applies to the composition, structure and architecture of the magnetocaloric heat exchanger. For example, properties such as low flow resistance, a high-volume density of magnetocaloric material, a high entropy change during the magnetic phase transition, production from cheaply available raw materials, effective heat transfer and a long service life are desirable. The latter requires high mechanical and chemical stability under operating conditions, i.e. in the presence of the heat exchange medium and the forces that occur during device operation. These are, in particular, the flow of the heat exchange medium, the magnetic attraction and the volume changes caused by repeated (de)magnetization and the associated phase transformations.

The focus on inexpensive raw materials of low criticality makes magnetocaloric materials particularly promising, which are primarily composed of readily available transition or main group metals as well as the comparatively uncritical rare earth metal lanthanum. Notable material classes include Heusler compounds, Fe₂P-based magnetocaloric compounds and lanthanum-iron-silicon-based alloys, where hydrogenated variants are particularly interesting for cooling applications under ambient conditions due to their increased Curie temperature and high-power density. By adjusting the composition, the ideal utilization range of magnetocaloric compounds such as lanthanum-iron-silicon-based alloys can be significantly reduced, so that such material classes are also relevant for low-temperature applications.

The required combination of the numerous properties mentioned above cannot be achieved satisfactorily with magnetocaloric solid materials. For example, due to their composition of oxophilic, moderately to strongly base metals (e.g. lanthanum) and poorly passivating metals (e.g. iron), they are intrinsically sensitive to corrosion, and the bonding structure of intermetallic materials such as lanthanum-iron-silicon-manganese alloys and Heusler compounds or iron phosphides makes them intrinsically brittle and susceptible to fracture. Lanthanum-iron-silicon-manganese alloys that have been hydrogenated to adjust their magnetic properties lose hydrogen through diffusion even at moderately elevated temperatures of below 100° C., which leads to an undesirable change in their magnetic functionality. Around the Curie temperature, which is in the range of room temperature and below for the primarily targeted applications, even partial dehydrogenation leads to a drastically accelerated migration of the hydrogen remaining in the lattice, which excludes the commercial use of partially hydrogenated lanthanum-iron-silicon alloys due to accelerated ageing and loss of performance. Therefore, such substrates are incompatible with deposition methods or modification processes that rely on elevated temperatures, such as sintering treatments used to reduce coating stresses, interdiffuse boundary layers, and improve adhesion or bonding of granular starting materials.

Due to the high chemical reactivity, damage-free processing and modification of such materials is challenging. Corrosion in the presence of organic or water-based cooling media leads to a loss of active material and, depending on the surrounding pH value, to the build-up of oxidic, hydroxidic or soluble oxidation products. Solid corrosion products can pass into the cooling circuit or adhere and cause a loss of thermal conductivity and a deterioration of the flow properties. In wet chemical coating processes such as electrodeposition, the desired coating reaction competes with the same corrosion processes, which in this scenario can adversely affect coating quality and adhesion.

### SUMMARY

One object of this disclosure is to provide a cost-effective, resource-saving, easy-to-perform, preferably harmless and fault-tolerant process by which a durable, robust, chemically and mechanically stable heat exchanger element with advantageous thermohydraulic and magnetic properties can be produced. In particular, a low flow resistance for a heat transfer medium flowing through it, a high-volume density of magnetocaloric material, a high entropy change during the magnetic phase transition, effective heat transfer and high material and corrosion stability under application conditions, in particular in water-based heat exchanger media and avoiding hydrogen embrittlement or loss, are desirable. Furthermore, a deposition solution suitable for carrying out the process, on the one hand nickel-based and on the other hand copper-based, is to be specified.

The problem is solved in accordance with this disclosure by a method having the features of claim 1. The corresponding heat exchanger element is the subject of claim 19.

Accordingly, the method according to this disclosure for producing a magnetocaloric heat exchanger element comprises the following steps:
providing a magnetocaloric substrate with a plurality of channels or pores, preferably forming continuous channels,
immersion of the substrate in a tempered aqueous reaction solution, which leads to an autocatalytic-chemical deposition of a metal coating on the surface of the substrate.

The substrate is also referred to as the matrix. The reaction solution is also referred to as the deposition solution. The term deposition bath is also used synonymously here.

The heat exchanger element is also called a heat transfer element or regenerator element. Abbreviations such as heat exchanger, heat transferrer or regenerator are also commonly used.

In the present application, the term “magnetocaloric” refers to the property that the substrate exhibits a technically usable magnetocaloric effect, in accordance with the understanding customary in the art. This is understood to mean the phenomenon of a temperature change in a magnetizable material when it is exposed to a changing magnetic field.

Continuous or continuous channels are to be understood in such a way that they pass through the heat exchanger element from one end to the other, in particular completely. The respective channel therefore has two open ends, whereby one opening is located in a first surface area of the heat exchanger element and the second opening is located in a second surface area that is different from the first surface area. A fluid, in particular a liquid, can therefore flow through the respective channel from one opening (inlet opening) to the other opening (outlet opening), whereby the direction of flow can also be reversed depending on the pressure conditions. Preferably, the channels formed by the pores are arranged in their entirety in such a way that they allow a directed flow through the heat exchanger element along a main flow direction or in the opposite direction.

In view of the preferred dimensions mentioned below, the pores or channels are also referred to as microchannels.

Coating the surface' here refers to the coating of the entire inner and outer surface of the substrate, which may come into contact with the heat transfer medium during subsequent use as a heat exchanger element. In particular, the walls of the pores or channels should be coated.

This disclosure is based on the consideration that solid magnetocaloric regenerators are poorly suited for effective heat exchange with the surrounding medium due to their moderate thermal conductivity. Instead, the present invention pursues the approach of creating an easily accessible and large inner surface by introducing a suitable pore architecture. Although this intensifies the heat exchange, it also increases the challenges in operation and processing: an enlarged surface in contact with the cooling medium exacerbates the corrosion problem, the increased geometric complexity of porous magnetocaloric materials places high demands on the conformity and homogeneity of the coating techniques in question in addition to avoiding undesirable side reactions, and due to their dimensions, the fine channels are particularly susceptible to blockage by solid corrosion products.

As recognized in the context of this disclosure, effective coating techniques capable of covering porous versions of magnetocaloric materials in a degradation-free, controlled and uniform manner with a secondary material that complements the properties of the substrate and compensates for its weaknesses through its surface-introduced functionality are desirable as a technological solution for creating high-performance, price-competitive and robust magnetocaloric heat exchangers. For example, encasing a magnetocaloric material in a rigid and plastically deformable coating increases its fracture resistance and reduces the risk of phase change-induced pulverization, while completely covering the surface with a chemically more resistant material improves its corrosion resistance and ageing stability. In order not to unnecessarily increase the thermal mass of the system and not to jeopardize the effective heat transfer from the magnetocaloric material to the surrounding cooling medium as a key performance parameter, thin and poorly thermally insulating coatings are desirable.

All in all, the required properties (in particular high corrosion resistance under operating conditions, mechanical protection of the magnetocaloric material, ductility, high thermal conductivity) can be achieved primarily through metal coatings. Applying these to complex-shaped, chemically and physically sensitive magnetocaloric substrates with large internal surfaces in a way that conforms to the surface, is defect-free and adheres well is challenging, but can be achieved with customized autocatalytic-chemical metal deposition processes that take into account the specific reactivity of magnetocaloric materials, their geometry and the desired combination of target properties, as described in more detail below.

The substrate treated according to the invention is particularly suitable for magnetocaloric applications, especially in cooling devices, with water-based heat exchanger media. Such heat exchanger media are ecologically advantageous, have good physical and chemical performance data (very high heat capacity, high thermal conductivity, relatively low viscosity) and are available in large quantities at low cost. In contrast to aprotic organic solvents or comparable non-aqueous cooling media, however, these are corrosive, which explains the need to protect the magnetocaloric functional material from chemical attack in accordance with the invention.

Advantageous embodiments of the invention, some of which have an independent inventive character, are the subject of the dependent claims in conjunction with the following description.

Advantageously, the substrate is monolithic (in the sense of one-piece, integral, contiguous) and preferably uniformly permeated by continuous pores. Preferably, the pores are essentially rectilinear and aligned parallel to each other, so that a plurality, in particular a plurality, of channels connected in parallel in terms of flow are formed. However, curved channels which deflect the direction of flow in order to intensify the heat exchange at the expense of friction are also covered by the invention.

It is preferred if the pores have a diameter between about 200 and about 1000 μm, are preferably monodisperse and preferably have a constant diameter along their course, and/or wherein walls are formed between the pores whose wall thickness is less than about 1000 μm, preferably less than about 600 μm. In the case of pores with a non-circular cross-section, the term ‘diameter’ is to be understood in a general sense as an extension along a cross-sectional direction. However, the diameter of the channels can also vary in the longitudinal direction. In particular, steps or offsets may be present.

Advantageously, the volume proportion of the pores of the substrate is in the range of about 10 to about 60%, preferably about 20 to about 55%, of the total volume.

In a variation of the concept, the substrate is present prior to immersion in the reaction solution as a loose or pressed bulk of, for example, granular, powdery, grainy or other particles, which are bonded together (materially bonded or “glued”) during the coating process by the metal coating that forms, so that the previously loose pore structure solidifies and becomes permanent. In particular, this means that the bulk material only becomes a monolithic-porous structure or form or a body during the deposition or coating process. The individual particles of the bulk material are effectively the building blocks or precursors/precursor particles of the subsequent solid. In general, the substrate can be poured/stacked/assembled/etc. from smaller, originally loose or non-bonded building units or building blocks such as particles, spheres, tubes or structured layers, which are then bonded together by metallization. These variations are possible both with the nickel plating described below and with copper plating.

Preferably, the substrate consists of a material based on a metal or a metal alloy from the group of transition or main group metals or on the rare earth metal lanthanum. The substrate is particularly preferably a Heusler alloy, a magnetocaloric compound of the iron phosphide type or a lanthanum-iron-silicon-based alloy, in particular a hydrogenated lanthanum-iron-silicon-manganese alloy.

Advantageously, the deposition bath has a temperature in the range from about 20 to about 90° C., preferably less than about 60° C. The metal coating is preferably carried out in such a way that the protective effect and stability of the deposited layer is not dependent on treatments at elevated temperatures, in particular above 90° C. (such as sintering treatments). In other words, preferably at no moment during the metal coating and during any pre-treatment before the coating and/or during any post-treatment after the coating of the substrate is a temperature effect of 90° C. on the substrate exceeded. Preferably, even about 60° C. is not exceeded.

It is preferable if the entire surface of the substrate, in particular the interior surfaces of the pore walls, is constantly in contact with fresh reaction solution during the deposition process, realized by passive flow through the pores caused by microconvection and/or active flow through the pores with the reaction solution caused by pumps or the like, whereby the substrate is aligned at least temporarily, preferably most of the time, during the deposition process in such a way that hydrogen bubbles forming during deposition are automatically removed from the pores. This is achieved in particular by a preferred vertical or inclined orientation of the pores, or by preferably constant rotation of the substrate in the solution. In the outer part of the substrate, contact surfaces that are created, for example, by contact or attachment, are preferably minimized both in their extent and their durability by selecting the smallest possible number and size and/or by regular turning or movement. In other words, constant contact points, a build-up of gas bubbles and stagnation of the reaction solution inside the substrate are avoided. This ensures a uniform coating everywhere on the substrate surface through constant contact with fresh, unused reaction solution. A preferred version of this implementation is a flat connected grid basket in which individual microchannels are placed, the positioning of which is changed by regular, not necessarily constant shaking.

In a preferred special case of the rotation method, the substrate is stored and rotated during the deposition process in a receiving cylinder that is rotated in the deposition bath. The receiving cylinder preferably has a lateral surface provided with through-flow openings for the reaction or deposition solution.

In a first advantageous variant, the deposition bath is a nickel-phosphorus deposition bath, which preferably comprises the following ingredients:
a Ni(II) source, preferably nickel sulphate
ligands, preferably citrate and/or other carboxylic, hydroxycarboxylic or aminopolycarboxylic acids, preferably in a molarity ratio of about 6:1 to about 10:1, measured in terms of the number of Ni(II) binding sites provided by the ligand, based on Ni(II)
alkalis, preferably ammonia and/or ammonium salts such as ammonium sulphate, particularly preferably ammonia supplemented with an ammonium salt
a catalytically convertible reducing agent, preferably hypophosphites such as potassium, sodium and/or ammonium hypophosphite, and/or hydrazine, borohydride and/or aminoboranes, preferably in a molarity ratio of about 2:1 to about 3:1, based on Ni(II)
optional stabilizers, preferably Pb(II) salts such as lead acetate
optionally surface-active compounds, preferably anionic surfactants such as sodium and/or potassium soaps, organosulfonates and/or sulfates, and/or neutral surfactants such as polysorbates.

In a second advantageous variant, the deposition bath is a copper deposition bath, which preferably comprises the following ingredients:
a Cu(II) source, preferably copper sulphate
ligands, preferably tartrate and/or other carboxylic, hydroxycarboxylic or aminopolycarboxylic acids, preferably in a molarity ratio of about 5:1 to about 10:1, measured in terms of the number of Cu(II) binding sites provided by the ligand, based on Cu(II)
alkalis, preferably alkali metal hydroxides and alkali metal carbonates or mixtures thereof, such as sodium hydroxide, potassium hydroxide or sodium carbonate
a catalytically convertible reducing agent, preferably formaldehyde, and/or glyoxylic acid and other aldehydes, preferably in a molarity ratio of about 2:1 to about 3:1, based on the number of molar equivalents required for the complete reduction of Cu(II)
optionally surface-active, preferably anionic surfactants such as sodium or potassium soaps, organosulfonates and/or sulfates, and/or neutral surfactants such as polysorbates
optional additives, preferably cyanides such as sodium cyanide and/or nitrogen- based heterocycles such as polypyridines and/or azoles
optional stabilizers, preferably oxo-anions, sulfur compounds and/or heterocycles
optionally Ni(II) salts, preferably nickel sulphate, preferably in a molarity ratio of about 1:4 to about 1:8, based on Cu(II).

To support the deposition reaction, the deposition solution is advantageously enriched with oxygen during the deposition process, in particular flushed with introduced air bubbles (compressed air) or other oxygen-containing gases or gas mixtures or corresponding gas bubbles. This also advantageously initiates or supports circulation of the solution in the separation vessel.

A particular advantage of the process according to the invention is that the metal deposition on the substrate occurs spontaneously, in particular without the prior introduction of catalytically active components such as palladium particles, with uniform coverage in the submicrometer range and within less than 10 minutes, preferably within less than 2 minutes, particularly preferably even in less than 30 seconds.

In order to promote the onset of the deposition reaction, it may be provided that the deposition process is optionally supported by applying an electrical voltage to the substrate or by galvanic contact of the substrate with a metal, in particular copper. Advantageously, such support measures are dispensed with, which reduces the apparatus complexity and simplifies the process control, but in any case the process according to this disclosure is compatible or compatible therewith, if desired or advantageous in special cases.

Advantageously, the deposition time is selected in such a way that a layer thickness of the metal coating in the range of about 3 to about 50 μm, preferably about 10 to about 30 μm, is achieved.

Advantageously, the substrate is cleaned in/with an organic solvent, in particular N-methylpyrrolidone, isopropanol, ethanol or acetone, before the deposition process and then dried if necessary. Preferably, no further pre-treatment of the starting workpiece is required.

Advantageously, the coated substrate is simply washed with water after the deposition process and then dried in air if necessary. Preferably, no further post-treatment of the coated workpiece is required. Instead, it can be used directly as a heat exchanger element or the like; in particular, thermal post-treatment is not required.

Advantageously, the deposition is electroless, i.e. not galvanic, i.e. without applying an (external) galvanic voltage. This means that no electrodes are required, which simplifies metallization. In addition, the contour accuracy of the deposition is particularly high due to the autonomy of the chemical reaction, which takes place simultaneously at all accessible catalytic interfaces, which is necessary for the uniform coating of the large inner surfaces of filigree structured magnetocaloric heat exchangers.

In addition, the direct wet-chemical growth of the metal film at comparatively low temperatures avoids thermal stresses that lead to material degradation such as dehydrogenation, which are common in gas-phase reactions such as CVD. Vacuum processes such as sputtering, which due to shading effects are also unable to coat hidden, only indirectly accessible inner surfaces as well as high-aspect pores and are instrumentally complex, are also avoided. Binding or coating with comparatively low-melting alloys such as solder can also be dispensed with. Such processes expose the workpieces to higher thermal loads and are difficult to realize in the form of the thin and very homogeneous metal films desired here (several um to several 10 μm thick), as molten metals are poorly suited to producing uniform wetting films due to their high viscosity and surface tension, especially in low thicknesses. This problem is further exacerbated by the structural complexity and small-scale dimensions of the components outlined here.

In a possible further development of the process, the coated substrate is immersed in a second temperature-controlled deposition bath with a second autocatalytic-chemical reaction solution after the deposition process and possibly after washing and drying, in order to form a second metal coating on the surface of the previously obtained metal coating.

Preferably, the magnetocaloric heat exchanger element produced according to the method of the invention is used in a heat pump or a magnetocaloric cooling or heating device, where an aqueous or water-based heat exchanger medium preferably flows through it during operation.

In addition to or instead of magnetocaloric heat exchanger elements, the method according to this disclosure can also be used to provide other objects made of corrosion-sensitive magnetocaloric materials with a mechanically stabilizing and/or chemical attack-protecting metal coating. Such a coating is particularly suitable for all objects which come into contact with aqueous solutions during operation or which are to be protected from oxidation in contact with air. In this respect, the present invention generally also comprises a method for coating corrosion-sensitive objects made of magnetocaloric materials, which can be of any shape due to the contour fidelity of the coating, wherein the object forms a substrate which is immersed in an aqueous reaction solution, and wherein the reaction solution leads to an autocatalytic-chemical deposition of a metal coating on the surface of the substrate. The process is particularly suitable for objects or substrates that are permeated with continuous pores or microchannels or have a fine, porous, granular or powdery structure, whereby internal, curved or partially concealed surfaces are also coated as completely and homogeneously as possible. However, it is also possible in principle to coat the walls of macrochannels.

A further aspect of the present invention, which is considered to be independently inventive, is to provide an aqueous reaction solution for producing a metal coating on a metallic substrate by autocatalytic chemical vapor deposition, in particular for use in a process of the type described above for producing a magnetocaloric heat exchanger element, comprising the following ingredients:
a Ni(II) source, preferably nickel sulphate
ligands, preferably citrate and/or other carboxylic, hydroxycarboxylic or aminopolycarboxylic acids, preferably in a molarity ratio of about 6:1 to about 10:1, measured in terms of the number of Ni(II) binding sites provided by the ligand, based on Ni(II)
alkalis, preferably ammonia and/or ammonium salts such as ammonium sulphate, particularly preferably ammonia supplemented with an ammonium salt
a catalytically convertible reducing agent, preferably hypophosphites such as potassium, sodium and/or ammonium hypophosphite, and/or hydrazine, borohydride and/or aminoboranes, preferably in a molarity ratio of about 2:1 to about 3:1, based on Ni(II)
optional stabilizers, preferably Pb(II) salts such as lead acetate
optionally surface-active compounds, preferably anionic surfactants such as sodium and/or potassium soaps, organosulfonates and/or sulfates, and/or neutral surfactants such as polysorbates.

In addition to such a nickel-based coating solution, the present disclosure also teaches a corresponding copper-based reaction solution comprising the following ingredients:
a Cu(II) source, preferably copper sulphate
ligands, preferably tartrate and/or other carboxylic, hydroxycarboxylic or aminopolycarboxylic acids, preferably in a molarity ratio of about 5:1 to about 10:1, measured in terms of the number of Cu(II) binding sites provided by the ligand, based on Cu(II)
alkalis, preferably alkali metal hydroxides and alkali metal carbonates or mixtures thereof, such as sodium hydroxide, potassium hydroxide or sodium carbonate
a catalytically convertible reducing agent, preferably formaldehyde, and/or glyoxylic acid and other aldehydes, preferably in a molarity ratio of about 2:1 to about 3:1, based on the number of molar equivalents required for the complete reduction of Cu(II)
optionally surface-active compounds, preferably anionic surfactants such as sodium or potassium soaps, organosulfonates and/or sulfates, and/or neutral surfactants such as polysorbates
optional additives, preferably cyanides such as sodium cyanide and/or nitrogen- based heterocycles such as polypyridines and/or azoles
optional stabilizers, preferably oxo-anions, sulphur compounds and/or heterocycles
optionally Ni(II) salts, preferably nickel sulphate, preferably in a molarity ratio of about 1:4 to about 1:8, based on Cu(II).

In summary, the invention describes autocatalytic-chemical deposition processes, in particular for nickel-phosphorus and copper coatings, which are tailored to magnetocaloric materials, in particular thermally and chemically sensitive compounds such as hydrogenated lanthanum-iron-silicon-manganese alloys. Such processes enable gentle (in particular, avoiding undesirable corrosion side reactions and avoiding thermal stress), uniform and effective coatings with metal films, which can also be applied to complex substrate geometries such as the technologically particularly relevant porous-monolithic configurations described above due to the excellent deposition conformity. This is ensured by a process control and composition of the deposition solutions tailored to the specific substrate reactivity.

Advantages achieved with this disclosure are in particular the following:
(i) Demonstration of a reliable corrosion-protective autocatalytic chemical coating reaction, in particular the first demonstration of a copper plating reaction, for magnetocaloric, temperature-sensitive materials. Using linear sweep voltammetry, a shift in the corrosion potential of the substrate material consisting of a hydrogenated lanthanum-iron-manganese-silicon alloy by more than 600 mV was demonstrated; with this value, the corrosion potential is in a range that corresponds to that of the pure coating metal copper (FIG. 5), which indicates reliable shielding of the substrate material from the surrounding electrolyte. Accompanying scanning electron microscopic examinations confirm the excellent freedom from defects, contour fidelity and homogeneity of the copper coating (FIG. 6, FIG. 7) as well as the high quality of the interface between the magnetocaloric lanthanum-iron-manganese-silicon substrate and the copper coating, which shows no noticeable traces of oxidation, but an intimate bond between substrate and coating (FIG. 7).
(ii) Due to the spontaneous and reliable onset of metallization reactions merely by immersion in the deposition solution(s), aggressive pretreatment steps (e.g. etching, pickling, sensitization or activation of the substrate surface) that can attack the substrate and create weak spots where corrosion can start prematurely (e.g. oxide precipitates that degrade the adhesion of the metal film or that are not completely covered and cause pores in the coating) or chemically attacked spots that show an increased sensitivity to corrosion can be avoided. For example, oxidic precipitations that impair the adhesion of the metal film or that are not completely covered and cause pores in the coating, or chemically attacked areas that are more susceptible to corrosion or are already corroded) should be completely avoided.
(iii) The aqueous deposition solutions have only a weak corrosive effect on the magnetocaloric substrates, and the rapid onset of metal deposition, which quickly leads to covering films, minimizes the time during which the substrate surface is in direct contact with the solution and can corrode in undesirable side reactions.
(iv) Direct metallization without pre-treatment steps simplifies process management: savings in production time, costs, material and waste; greater process reliability due to fewer interlocking work steps that are dependent on each other to ensure product quality.
(v) By omitting aggressive pre-treatment steps in combination with the suppression of corrosion by the bath composition and the rapid covering of the sensitive surface of the magnetocaloric material, higher quality coatings are achieved, and material damage and weak points are avoided.
(vi) Uncontrolled cementation reactions between the metal ions in the deposition baths (in particular Ni(II), Cu(II)) and the base substrate, which result in poorly adhering coatings, corrosion and/or the formation of powdery or voluminous reaction products (reduced Ni or Cu, oxidized substrate components), are avoided.
(vii) The deposition baths allow a high reactivity even at low deposition temperatures of ideally below 60° C., which are noticeably below the industrially usual temperatures of autocatalytic-chemical Ni—P and Cu deposition reactions, but are necessary for the integrity of sensitive magnetocaloric substrates, which is expressed in a rapid and spontaneous onset of the deposition reaction as well as in high deposition rates of typically 4-10 μm h⁻¹ on these substrate materials. The metal deposition on the substrate starts spontaneously (in particular without the use of catalytically active nuclei consisting of palladium, for example) within less than 10 minutes, preferably less than 2 minutes. However, the deposition time selected to achieve the desired layer thicknesses is usually significantly longer than the onset time and typically takes several hours, for example 2 to 4 hours.
(viii) The method according to the invention enables the realization of surface-faithful and uniform (contour-faithful) metal deposits on magnetocaloric substrates using simple wet-chemical means. Complex instrumentation, high energy requirements, high control requirements and the need for a controlled reaction atmosphere (as in the case of gas-phase reactions) are avoided. The thermal load on the substrates is kept low.
(ix) Compared to alternative designs such as compacted and sintered granules, the architecture proposed here ensures better flowability of the heat exchanger and a more favorable surface-to-volume ratio.

### BRIEF DESCRIPTION OF THE DRAWINGS

An embodiment of this disclosure is explained in more detail below with reference to the accompanying drawings. They show:

FIG. 1 is an exemplary, highly simplified view of a porous, monolithic magnetocaloric substrate, here with a large number of continuous, rectilinear, parallel and monodisperse pores,

FIG. 2 is an overview, in the form of a flow chart, of the process sequence for coating a substrate of this type,

FIG. 3 is a schematic representation of an apparatus used for coating the substrate, in this case with a microchannel substrate stored upright in a reaction solution,

FIG. 4 is a schematic representation of a rotating pick-up cylinder holding a plurality of substrates during coating, as an example of alternative substrate metallization with automated sample movement,

FIG. 5 is an electrochemical characterization of the corrosion behavior of an untreated, hydrogenated lanthanum-iron-manganese-silicon alloy substrate, of such a substrate which has been copper-plated according to the present invention, and of a pure Cu reference sample,

FIG. 6 illustrates a scanning electron micrograph at two different magnifications showing a top view of a platelet coated with copper according to the present invention and consisting of a hydrogenated lanthanum-iron-manganese-silicon alloy; no exposed alloy substrate can be seen, but only the contour-faithful and compact copper film covering the entire surface, and

FIG. 7 is a scanning electron micrograph of the fracture edge of a plate coated with copper according to the present invention, which consists of a hydrogenated lanthanum-iron-manganese-silicon alloy; the plate (upper half of the picture) can be easily distinguished from the finely crystalline copper film, which is compact, homogeneous and intimately bonded to it, due to its granular structure; moreover, no traces of corrosion are visible at the interface, which confirms the integrity of the coating process.

### DETAILED DESCRIPTION

This disclosure comprises the realization of a monolithic-porous magnetocaloric architecture, mechanically reinforced and protected against corrosion by an external metal coating, for use as a long-term stable and effective temperature conversion element in magnetocaloric heat pumps and cooling devices by means of an autocatalytic-chemical deposition process.

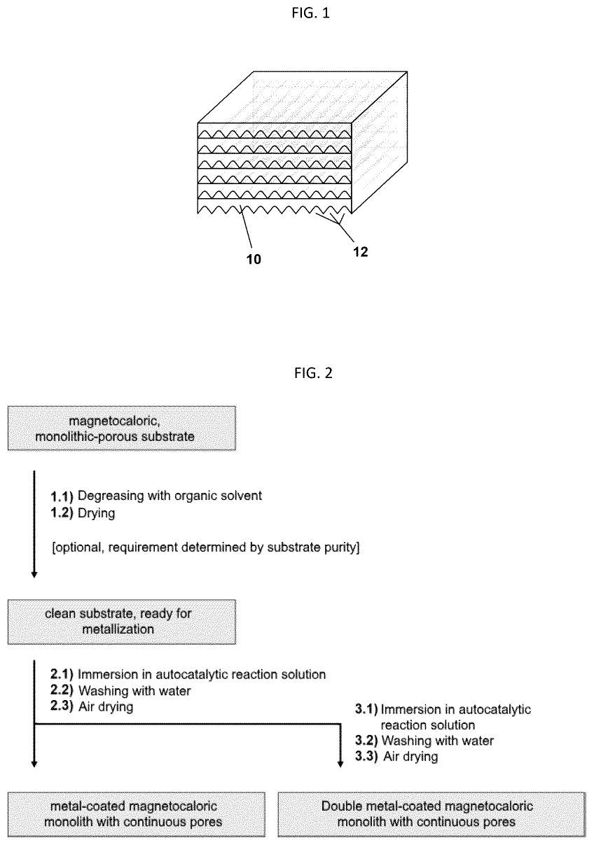

For this purpose, a preferably monolithic magnetocaloric substrate is provided, which consists, for example, of hydrogenated lanthanum-iron-silicon-manganese alloys, Heusler compounds or iron phosphide-based magnetocaloric materials and which has continuous, ideally parallel and monodisperse pores. An example structure is shown schematically in FIG. 1. In this example, the starting product or precursor for the desired heat exchanger element formed by the untreated substrate is cuboid in shape with a first end face facing the viewer and, opposite, a second end face facing away from the viewer (not visible). The pores extend through the cuboid from the first to the second end face, thus forming continuous, parallel (micro) channels with walls of substrate material in between, thus enabling a directed flow of a fluid heat transfer medium, also known as a refrigerant, through the cuboid in or against the direction of the arrow.

After an optional cleaning step with one or more organic solvents (e.g. with N-methylpyrrolidone, isopropanol, ethanol or acetone), but otherwise preferably no further pretreatment steps, the substrate is autocatalytically-chemically coated with a metal by immersion in a deposition bath of suitable reactivity. A detailed specification of the characteristics specifically preferred for this application can be found below. The desired average coating thicknesses are typically between 3 and 50 μm, ideally between about 10 and about 30 μm. In addition to a single coating, coating with one or two metals can also be carried out in two separate deposition steps. The flow chart of the entire process is summarized in FIG. 2.

Favorable architectures use the magnetocaloric material in maximum (wall) thicknesses of approximately 1000 μm, ideally below 600 μm, to ensure good heat transfer from the magnetocaloric functional material, have a sufficiently high porosity and evenly distributed, continuous, linear and monodisperse pores with diameters of approximately 200-1000 μm for easy flowability, but at the same time have a sufficiently high-volume fraction of magnetocaloric material to provide a good power density. For this purpose, global porosities of about 10% to about 60% should be aimed for, ideally about 20% to about 55%. The pores do not have to have circular cross-sections; other cross-sections are also possible. In particular, elongated or slit-like pores are permissible if they are limited in one dimension to the above-mentioned value of around 200-1000 μm. Viewed in cross-section, an area of 1 cm² in the direction of flow preferably has a number of many 10 to several 100, in particular 100 to 800 microchannels, whereby the areal density of pores results primarily from the dimensioning of the pores and their distribution in the magnetocaloric matrix.

Suitable monolithic-porous substrates for the coating can be realized, for example, constructively by stacking and joining (structured) plates or by 3D printing, subtractively, for example, by water jet cutting or wire erosion of solid materials. These details are to be understood as examples. The process described here assumes the provision of suitable substrates, preferably with a chemically reduced or at least not noticeably oxidized surface of high quality. The feasibility is empirically proven and corresponding samples are commercially available. However, details of the production of the starting substrates are not the subject of the present description.

As deposition baths, those for the production of nickel-phosphorus and copper coatings are particularly noteworthy. While nickel-phosphorus stands out primarily due to its high corrosion resistance, copper is particularly recommended for this field of application due to its plasticity and excellent thermal conductivity.

The nickel-phosphorus deposition bath preferably contains:
(i) a Ni(II) source (preferably nickel sulphate), which provides the precursor ions required for the metal coating (preferably in the range of 0.03-0.4 mol L⁻¹, in particular 0.06-0.3 mol L⁻¹)
(ii) ligands for ensuring the solubility of the metal salts used in the alkaline medium, as well as for complexing the ions and for adjusting their reactivity (preferably citrate or other carbonic, hydroxycarboxylic or aminopolycarboxylic acids) (preferably in the range of 0.04-0.55 mol L⁻¹, in particular 0.09-0.4 mol L⁻¹)
(iii) alkalis for setting a sufficiently high pH value to reduce the corrosiveness of the solution towards the substrate (preferably ammonia (preferably in the range of 0.6-2.4 mol L⁻¹, in particular 1.0-2.0 mol L⁻¹) and ammonium salts such as ammonium sulphate (preferably in the range of 0.3-1.2 mol L⁻¹, in particular 0.5-1.0 mol L⁻¹), especially preferably ammonia supplemented with an ammonium salt to build up a buffer, with subsequent dosing of ammonia, either continuously or in a batch process after half of the reaction time, in order to keep the pH stable
(iv) a sufficiently strong, catalytically convertible reducing agent (preferably hypophosphites such as potassium, sodium or ammonium hypophosphite, but also hydrazine, borohydride or aminoboranes) (preferably in the range of 0.1-0.5 mol L⁻¹, in particular 0.2-0.35 mol L⁻¹)
(v) optional, but strongly recommended stabilizers to prevent homogeneous nucleation (for example Pb(II) salts such as lead acetate) (for example in the range of 2-25 ppm, especially 4-9 ppm)
(vi) optionally, but strongly recommended, surface-active compounds to improve the wettability of the substrate surface, to accelerate the detachment of gas bubbles on the substrate to counteract deposition inhomogeneities, and to optimize solution reactivity, but avoiding the formation of excessively stiff foams or the precipitation of poorly soluble metal soaps, which can close the substrate pores and counteract uniform metallization (preferably anionic surfactants such as sodium or potassium soaps, organosulfonates and sulfates, but also neutral surfactants such as polysorbates) (e.g. up to 2 mmol L⁻¹, in particular 0.01-0.7 mmol L⁻¹).

The copper deposition bath preferably contains:
(i) a Cu(II) source (preferably copper sulphate), which provides the precursor ions required for the metal coating (preferably in the range of 0.02-0.2 mol L⁻¹, in particular 0.03-0.09 mol L⁻¹)
(ii) ligands for ensuring the solubility of the metal salts used in the alkaline medium, as well as for complexing the ions and for adjusting their reactivity (preferably tartrate or other carbonic, hydroxycarboxylic or aminopolycarboxylic acids) (preferably in the range of 0.06-0.6 mol L⁻¹, in particular 0.1-0.3 mol L⁻¹)
(iii) Alkalis for adjusting a sufficiently high pH value (preferably alkali metal hydroxides and alkali metal carbonates or mixtures thereof, such as sodium hydroxide, potassium hydroxide or sodium carbonate) (preferably in the range of 0.15-0.6 mol L⁻¹, in particular 0.2-0.4 mol L⁻¹)
(iv) a sufficiently strong, catalytically convertible reducing agent (preferably formaldehyde, but also glyoxylic acid and other aldehydes) (preferably in the range of 0.15-1.0 mol L⁻¹, in particular 0.2-0.5 mol L⁻¹)
(v) optional but strongly recommended surface-active compounds to improve the wettability of the substrate surface, to accelerate the detachment of gas bubbles on the substrate to counteract deposition inhomogeneities, and to optimize solution reactivity, but avoiding the formation of excessively stiff foams or the precipitation of poorly soluble metal soaps, which can close the substrate pores and counteract uniform metallization (preferably anionic surfactants such as sodium or potassium soaps, organosulfonates and sulfates, but also neutral surfactants such as polysorbates) (e.g. up to 2 mmol L⁻¹, in particular 0.01-0.7 mmol L⁻¹)
(vi) optional, but strongly recommended additives to improve the ductility and to stabilize the deposition solution (preferably cyanides such as sodium cyanide or nitrogen-based heterocycles such as polypyridines or azoles) (exemplary up to 3 mmol L⁻¹, in particular 0.02-0.8 mmol L⁻¹)
(vii) optional, but strongly recommended additional stabilizers to prevent homogeneous nucleation under deposition conditions (e.g. oxo-anions, sulfur compounds, heterocycles) (e.g. up to 1 mmol L⁻¹)
(viii) optional, but strongly recommended Ni(II) salts for the optimization of reactivity (preferably nickel sulfate) (for example in the range of 0.003-0.03 mol L⁻¹, in particular 0.006-0.018 mol L⁻¹).

To initiate the reaction, the substrate is simply immersed in the deposition bath heated to a reaction temperature below 90° C., ideally below 60° C. The deposition starts spontaneously and uniformly on the entire substrate surface within less than 10 minutes, ideally in less than 2 minutes (indicated by lively gas development), but can be additionally stimulated by applying an electrical voltage, electrical contact of the substrate with a less noble metal such as aluminum or by contact with metallic copper. The bath is preferably flushed with air bubbles during heating and deposition in order to enrich it with oxygen and circulate it. It is also possible to inject other oxygen-containing gases or pure oxygen.

When positioning the substrates stationary in the deposition solution, it is preferable to ensure that the pores are arranged diagonally to vertically so that the hydrogen bubbles that form during deposition are removed from the pores automatically and quickly by buoyancy, which ensures both permanent wetting of the entire substrate surface with deposition solution (and thus a uniform coating) and constant renewal of the deposition solution inside the substrate. This can be achieved, for example, by tilting the substrates sideways against the vessel wall, by placing them on one side of a raised area on the bottom of the vessel, by using a concave curved vessel bottom or by placing the substrates on a grid or similar holder suspended in the solution.

After a deposition time corresponding to the generation of the desired layer thickness, the substrate is removed from the solution, preferably washed thoroughly with water, dried in air and is ready for integration into a heat pump or cooling device. Further post-treatment steps are advantageously not required.

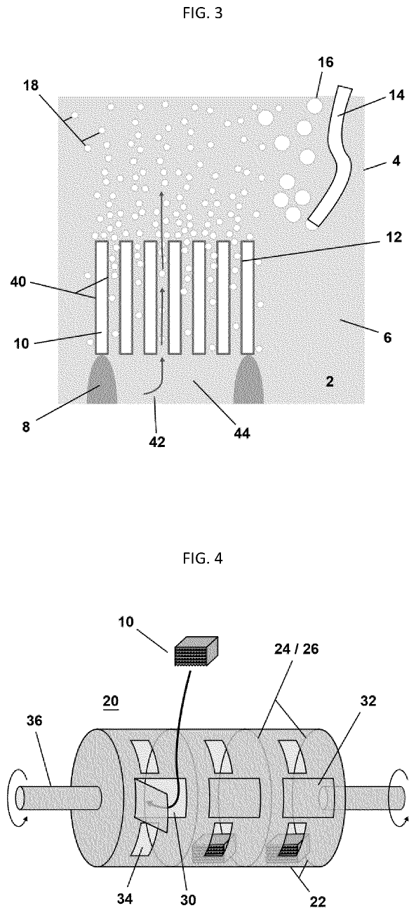

An example of the reaction process described above is shown in FIG. 3. In order to avoid permanently inaccessible contact points between the substrate to be metallized and the holder, which can cause weak points or pores in the coating, it is also advisable to turn the samples regularly. Ideally, this should be done automatically, while maintaining the most open possible access to the deposition bath and preventing substrates from falling out of the sample holder. It is also important to avoid rubbing several substrates against each other and damage to the brittle substrate material or the coating resulting from friction or impact with the moving sample holder, e.g. due to excessively hard surfaces.

In summary, FIG. 3 shows a deposition bath 2 used in the process according to the invention. A deposition solution 6 or liquid of the type mentioned above is located in a suitable vessel 4, which is preferably accessible from above and is preferably trough-like. The vessel 4 contains one or more holders 8 for the substrate 10 to be coated, which, as described above, is preferably a monolith of a magnetocaloric material traversed by parallel pores or (micro) channels 12. The substrate 10 is preferably aligned in such a way that the microchannels 12 are aligned vertically. In this example, the holders 8 are mounted on the base of the vessel 4 and support the inserted or loosely placed substrate 10 from below. Suitable shaping minimizes the contact between the holders 8 and the substrate 10 to a few point contacts. The filling level of the deposition solution 6 is such that the substrate 10 is completely immersed in the deposition solution 6. Due to the selected mounting, the substrate 10 is in contact with the deposition solution 6 on all sides. In particular, the underside and the upper side of the substrate 10 with the inlet and outlet openings of the microchannels 12 located there are easily accessible. The deposition solution 6 is adjusted to a desired process temperature by a temperature control device not shown here.

Through an air hose 14 immersed in the deposition solution 6, an air flow is introduced into the deposition solution 6 at its outlet opening with the aid of an associated compressor pump or the like. The air bubbles 16 released in this way and ultimately rising upwards enrich the deposition solution 6 with oxygen and circulate it within the vessel 4, thus to a certain extent having the function of an agitator. In this way, during the deposition process, there is a directed flow of the deposition solution 6 from bottom to top through the pores or microchannels 12 of the substrate 10 (and along the outer walls), as indicated by the flow arrows 42. As a result, the entire inner and outer surface of the substrate 10, including the pore walls, is covered with a uniform, thin metal coating 40. Hydrogen bubbles 18 released during the autocatalytic coating reaction rise upwards in the microchannels 12 and escape into the surrounding atmosphere at the surface of the deposition solution 6.

Of course, several substrates can also be coated simultaneously next to each other in a suitably large tank with a number of holders. In this case, it is preferable to ensure sufficiently large distances between the workpieces (substrates) to be coated, which should not touch each other during handling.

A possible modified configuration is the individual storage of the substrates to be coated in the compartmentalized cells of a cylinder provided with openings and rotating in the deposition bath, which consists of a material that is not chemically attacked by the bath and is soft enough, at least in the areas that come into contact with the substrate (inner walls of the cells), to prevent mechanical damage to the substrates during coating (e.g. silicone-coated metal).

Such a receiving cylinder 20 is shown schematically in FIG. 4. The receiving cylinder 20 is designed as a hollow cylinder with a lateral surface 22 enclosing the interior and end caps or end walls 24. Seen in the longitudinal direction, the cylindrical interior is subdivided by intermediate walls 26 into individual cells 28 or compartments, each of which is intended for holding an individual workpiece (substrate 10). For the insertion and subsequent removal of the respective monolith or workpiece, each cell is provided with an access opening 30 of sufficient size, which can be closed for the deposition process by a lockable closure flap 32. This prevents the workpieces from falling out during the coating process. In order to ensure sufficient flow through the individual cells 28 during the coating process, the lateral surface 22 of the receiving cylinder 20 has a large number of flow openings 34, for example slit-like openings, distributed around the circumference and in the longitudinal direction, which are kept so small that the workpieces cannot fit through them. At the end faces, the receiving cylinder 20 is connected to a drive shaft 36, which is rotatably mounted in the deposition bath 2 and preferably driven by a motor, so that the receiving cylinder 20 can be rotated in the deposition bath 2 during the deposition or coating process. The axis of rotation is preferably aligned horizontally, so that the individual workpieces tumble around in the lower region of the receiving cylinder 20 at a rotation speed that is not too high and are constantly turned over.

The direct autocatalytic wet-chemical coating of magnetocaloric substrates has actually demonstrated effective corrosion protection in tests, for example through the reduction of the corrosion potential to the value of the coating metal measured in linear voltametric measurements, which indicates excellent freedom from defects of the coating.

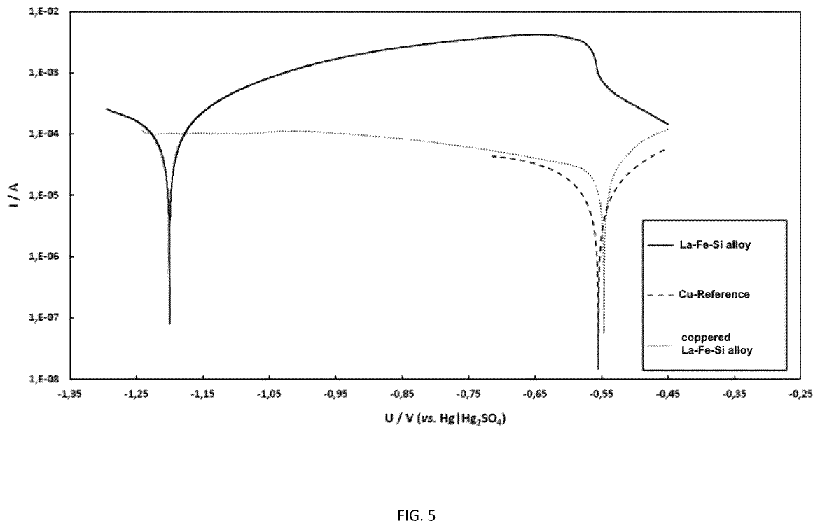

By way of example, reference is made to FIG. 5, which shows a diagrammatic representation of the corrosion potential measured on various samples, namely an untreated, hydrogenated lanthanum-iron-manganese-silicon alloy substrate, such a substrate that has been copper-plated in accordance with the present invention, and a pure Cu reference sample. The measurement is based on a three-electrode setup with a platinized Ti grid as counter electrode, various metal plates as working electrode, and a mercury-mercury sulfate reference electrode. Further parameters are: electrolyte: high-purity (>18.2 MΩcm) water, mixed with 100 mM TRIS buffer and 20 mM citric acid; feed rate: 0.25 mV/s; control using a Gamry Reference 600 potentiostat.

Even complex-shaped magnetocaloric workpieces such as the above-mentioned microchannel monoliths could be metallized easily, reliably, quickly and uniformly with the developed deposition reactions using scalable, material-friendly processes based on inexpensive basic chemicals.

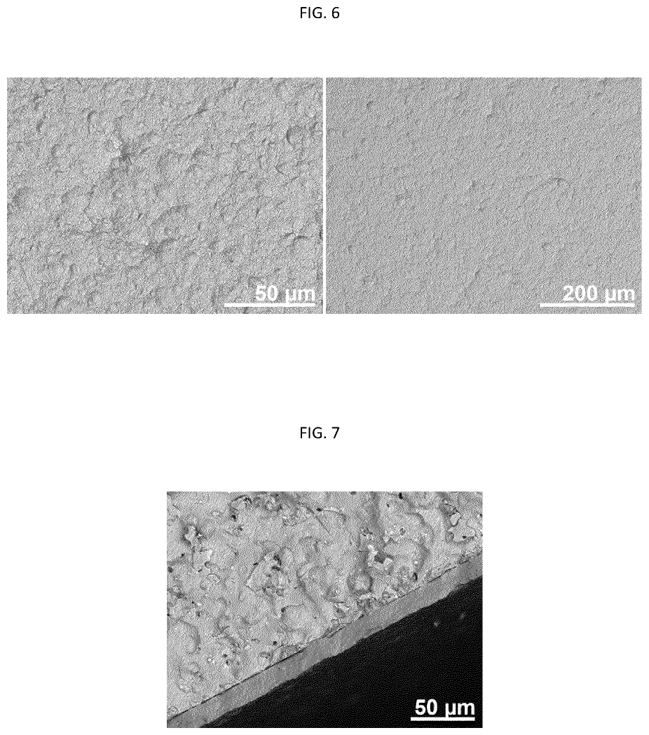

The high quality of the deposited metal film was also demonstrated by scanning electron microscopy (see FIGS. 6 and 7), as was the successful, homogeneous and opaque metallization of the inner surfaces of microchannel monoliths.

All deposition and processing steps actually take place at comparatively low temperatures. More thermally activated methods for deposition (e.g. chemical or physical gas phase synthesis, immersion in molten metal) or for improving coating quality (e.g. improving coating adhesion, sintering a coating or reducing stresses through thermal treatment), which cannot be readily applied to temperature-sensitive magnetocaloric substrates, are not required.

The mechanical toughness of the copper film was investigated in fracture tests, in which an increase in the mechanical stability and fracture resistance of the intrinsically brittle magnetocaloric monoliths due to the metal coatings was demonstrated.

The improved quality of metallized magnetocaloric microchannel substrates in terms of coating homogeneity, freedom from defects and corrosion protection by avoiding aggressive process steps was also demonstrated: The inclusion of otherwise common pretreatment methods such as etching the substrate surface with dilute acids (e.g. hydrochloric or sulfuric acid) or immersion in sensitizing and activating solutions (e.g. hydrochloric solutions of SnCl₂ or PdCl₂), which are common for the preparation of chemical metallizations, led to a deteriorated adhesion of the metal films and produced visible and noticeable corrosion marks in contrast to the direct metallization proposed here.

The need to apply a catalyst is unnecessary in the present case due to the spontaneous initiation of the reaction when the substrate is immersed in the deposition solutions.

### LIST OF REFERENCE SYMBOLS

2 deposition bath
4 vessel
6 reaction or deposition solution
8 holder
10 substrate
12 (micro) channel
14 air hose
16 air bubbles
18 hydrogen bubbles
20 receiving cylinder
22 lateral surface
24 end wall
26 intermediate wall
28 cell
30 access opening
32 closure flap
34 flow opening
36 drive shaft
40 metal coating
42 flow arrow
44 underflow area

1. A method of manufacturing a magnetocaloric heat exchanger element, comprising:
providing a magnetocaloric substrate with a plurality of flow-through channels or pores, which form continuous channels; and
immersing the substrate in a tempered aqueous reaction solution, which leads to an autocatalytic-chemical deposition of a metal coating on the surface of the substrate.

2. The method according to claim 1, wherein the substrate is monolithic and uniformly permeated by continuous pores.

3. The method according to claim 1, wherein the pores have a diameter between about 200 and about 1000 μm, are monodisperse and have a constant diameter along their course, and/or wherein walls are formed between the pores, the wall thickness of which is less than about 1000 μm.

4. The method according to claim 1, wherein a volume fraction of the pores of the substrate is in the range from about 10to about 60% of the total volume.

5. The method according to claim 1, wherein the substrate, prior to immersion in the reaction solution, is present as a loose or pressed bulk or stack of smaller structural units, which are bonded together during the coating process by the metal coating that forms.

6. The method according to any one of the preceding claim 1, wherein the substrate is a Heusler alloy, a magnetocaloric compound of an iron phosphide type or a lanthanum-iron-silicon-based alloy.

7. The method according to claim 1, wherein the reaction solution has a temperature in the range from about 20 to about 90° C.

8. The method according to claim 3, wherein an entire surface of the substrate, including interior surfaces of the pore walls, is constantly in contact with fresh reaction solution during the deposition process, realized by a passive flow through the pores caused by microconvection and/or an active flow through the pores with the reaction solution caused by pumps, and wherein the substrate is at least temporarily oriented during the deposition process in such a way that hydrogen bubbles forming during the deposition are automatically removed from the pores.

9. The method according to claim 1, wherein the reaction solution is effective as a nickel-phosphorus deposition bath.

10. The method according to claim 9, wherein the reaction solution comprises:
a Ni(II) source, preferably nickel sulphate;
ligands, in a molarity ratio of about 6:1 to about 10:1, measured in terms of the number of Ni(II) binding sites provided by the ligand, based on Ni(II);
alkalis; and
a catalytically convertible reducing agent in a molarity ratio of about 2:1 to 3:1, based on Ni(II).

11. The method according to claim 1, wherein the reaction solution is effective as a copper deposition bath.

12. The method according to claim 11, wherein the reaction solution comprises:
a Cu(II) source;
ligands, in a molarity ratio of about 5:1 to about 10:1, measured in terms of the number of Cu(II) binding sites provided by the ligand, based on Cu(II);
alkalis;
a catalytically convertible reducing agent in a molarity ratio of about 2:1 to about 3:1, based on the number of molar equivalents required for the complete reduction of Cu(II).

13. The method according to claim 1, wherein the metal deposition on the substrate starts spontaneously, without prior introduction of catalytically active components, with uniform coverage in the submicrometer range and within less than about 10 minutes.

14. The method according to claim 1, wherein the coated substrate, after the deposition process, is immersed in a second temperature-controlled deposition bath with a second autocatalytic-chemical reaction solution to form a second metal coating on the surface of the previously obtained metal coating.

15. The method according to claim 1, wherein no pretreatment steps from the group consisting of etching, pickling, grinding, polishing, sensitization and/or activation of the substrate surface are carried out before the substrate is immersed in the reaction solution.

16. The method according to claim 15, wherein before the substrate is immersed in the reaction solution for pretreatment, the substrate is cleaned with water and/or an organic solvent, and then dried.

17. The method according to claim 1, wherein the deposition takes place without current.

18. The method according to claim 1, further comprising flowing a heat transfer fluid through the channels or pores after the metal coating has taken place.

19. A magnetocaloric heat exchanger element manufactured by the method according to claim 1.

20. A heat pump or cooling or heating apparatus comprising heat exchanger element according to claim 20.

21. The method according to claim 3, where the wall thickness is less than about 600um.

22. The method according to claim 4, wherein the volume fraction of the pores is in the range of about 20 to about 55%.

23. The method according to claim 5, wherein the smaller structural units comprise at least one of particles, spheres, tubes or structured layers.

24. The method according to claim 6, where the lanthanum-iron-silicon-based alloy is a hydrogenated lanthanum-iron-silicon-manganese alloy.

25. The method according to claim 7, wherein the temperature of the reaction solution is less than 60° C.

26. The method according to claim 10, wherein the ligands include at least one of citrate and/or other carboxylic, hydroxycarboxylic or aminopolycarboxylic acids, wherein the alkalis include at least one of ammonia and/or ammonium salts, and wherein the catalytically convertible reducing agent includes hypophosphates.

27. The method according claim 26, wherein the hypophosphates include at least one of sodium and/or ammonium hypophosphite.

28. The method according to claim 10, wherein the reaction solution further comprises at least one stabilizer and at least one surface-active compound.

29. The method according to claim 28, wherein the stabilizer is lead acetate, and wherein the surface-active compound includes at least one of anionic surfactants, organosulfonates, sulfates, or polysorbates or other neutral surfactants.

30. The method according to claim 12, wherein the Cu(II) source is copper sulphate, wherein the ligands include at least one of tartrate and/or other carboxylic, hydroxycarboxylic or aminopolycarboxylic acids, wherein the alkalis include at least one of alkali metal hydroxides, alkali metal carbonates, sodium hydroxide, potassium hydroxide or sodium carbonate, and wherein the catalytically convertible reducing agent includes at least one of formaldehyde, glyoxylic acid and other aldehydes.

31. The method according to claim 12, wherein the reaction solution further comprises at least one of a surface-active compound, an additive, a stabilizer, or a Ni(II) salt in a molarity ration of about 1:4 to about 1:8 based on Cu(II).

32. The method according to claim 30, wherein the surface-active compounds include at least one of sodium soap, potassium soap or other anionic surfactants, organosulfonates, sulfates, and/or polysorbates or other neutral surfactants,
wherein the additives include at least one of sodium cyanide or other cyanides, polypyridines, azoles or other nitrogen-based heterocycles,
wherein the stabilizers include at least one of oxo-anions, sulfur compounds and/or heterocycles, and
wherein the Ni(II) salt is nickel sulphate.

33. The method according to claim 13, wherein the metal deposition on the substrate starts spontaneously within less than 2 minutes.

34. The method according to claim 33, wherein the metal deposition on the substrate starts spontaneously within less than 30 seconds.
